(19) United States
(12) Patent Application Publication
(10) Pub. No.: US 2005/0060648 A1
(43) Pub. Date: Mar. 17, 2005

(54) Document transformation

(76) Inventors: Thomas Fennelly, County Laois (IE); Ronan Charles Brady, County Dublin (IE)

Correspondence Address: JACOBSON HOLMAN;PROFESSIONAL LIMITED LIABILITY COMPANY, 400 SEVENTH STREET, N.W., WASHINGTON, DC, 20004, US

(21) Appl. No.: 10/902,125

(22) Filed: Jul. 30, 2004

Related U.S. Application Data
(63) Continuation of application No. PCT/IE03/00018, filed on Feb. 3, 2003.

(30) Foreign Application Priority Data
Feb. 4, 2002 (IE) 2002/0073

(51) Int. Cl. G06F 17/00

(52) U.S. Cl. 715/523

(57) ABSTRACT

A document transformation system (1) comprises a layout server (2) which dynamically generates output documents for delivery to a user device. The layout server (2) selects a layout template (5) according to user device and delivery channel characteristics and fragments from source documents (6) are inserted into the layout templates (5). Information to assist with selection of a template (5) is retrieved from a user device information repository (3).

### FIELD OF THE INVENTION

The invention relates to transformation of a source document to a target document suitable for one of multiple delivery channels.

### PRIOR ART DISCUSSION

In recent years, the small set of web browsers that are familiar to most users of personal/office computers (PCs) has been joined by a large variety of alternative content browsers that are available on a large variety of computing/display platforms, especially mobile devices. The shape, size and processing capability varies considerably among these devices. Furthermore, to cater for the different capabilities of these devices, alternative representations of content have appeared. These are usually in the form of alternative markup languages. Languages such as Compact HTML, XHTML Basic and Wireless Markup Language form part of this collection of alternatives. There are mechanisms to transform the markup of the source content into an alternative markup for the viewing device. The translation of markup, however, may not be sufficient to give a good viewing experience to the end user. For example, a three-column presentation of content for a PC browser would be very cramped on a narrow form-factor mobile Personal Digital Assistant.

Content (text, images, and other software-accessible media) can be brought together into a single document. The structure of the document would be such that it suits the agent used to view the document. Web pages are normally designed with a structure suited to a PC browsing agent equipped with a moderately sized screen. It is for this reason that the World-Wide Web (an Internet collection of inter-linked HTML files) is proliferated with pages that are best viewed on a PC using mainstream browsing applications. Attempting to view the Web using a smaller screen, or one with an unusual aspect ratio, generally gives poor results. The content does not fit, there is too much or too little, or the document structure makes it difficult to navigate. For example, a lengthy document on a small browser might force the user to scroll excessively in order to locate the desired part of the document. Content that is not intelligible to the browser could be processed by the server to make it intelligible, but the structure of the resulting document might still not be suitable. Converting a long HTML document into a long WML document does not make it any easier for a WAP phone user to navigate the document.

There are a number of techniques for producing a document that represents the same content, but whose structure is different according to the viewing device. These generally involve a different process for each structure to be generated. Each process acquires different fragments of the original content and outputs these fragments surrounded by structural markup, typically “table” tags that organise the content fragments into rows and columns. The introduction of new devices and/or new structures necessitates the introduction of new processes. This can be a costly administrative and maintenance task.

Therefore, the invention is directed towards providing a document transformation method and system for provision of documents to users in an environment comprising diverse content viewing devices.

### SUMMARY OF THE INVENTION

According to the invention, there is provided a document transformation system comprising means for transforming a source document to a target document suitable for delivery to one of a plurality of potential user devices,
wherein the system comprises a layout server for identifying a suitable layout template according to characteristics of the user device, and for combining the layout template with a source document to provide an output document.

In one embodiment, the system further comprises a multi-channel server for performing additional transformation of the output document to provide the target document.

In another embodiment, the multi-channel server comprises means for performing lower-level channel-specific transformation.

In a further embodiment, the system stores a bank of layout templates and a bank of source documents, and the templates and the source documents have inter-linked tags.

In one embodiment, the system comprises a request handler comprising means for dynamically linking a source document to a layout template according to both user request attributes and device characteristics.

In another embodiment, the layout server comprises means for operating in a push mode in which source document fragments are pushed into a layout template according to source document tags, and in a pull mode in which source document fragments are pulled into a layout template according to template tags.

In a further embodiment, the system further comprises a device information repository of user device characteristics, and the layout server comprises means for determining user device characteristics for a session from the repository, and using the characteristics to choose a layout template.

In one embodiment, the layout templates have a hierarchical structure.

In another embodiment, each source document has a markup structure and the layout server comprises means for representing tags of the source document as nodes in a document object model.

In a further embodiment, the layout template comprises placeholder tags that reference structural nodes within the source document, and the layout server comprises means for replacing tags by source document content fragments.

In one embodiment, the layout template placeholder tags directly reference source document content fragments.

In another embodiment, the layout template placeholder tags indirectly reference source document content fragments via an intermediate map.

In a further embodiment, the layout template is structured so that the output document is also suitable for delivery on a particular delivery channel.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a diagram illustrating a document transformation system;

FIG. 2 is a flow diagram illustrating transformation of a document;

FIGS. 3 and 4 are diagrams showing direct and indirect references between source and target content; and

FIGS. 5 and 6 are diagrams illustrating mappings of particular items of content such as document headers and bodies.

### DESCRIPTION OF THE EMBODIMENTS

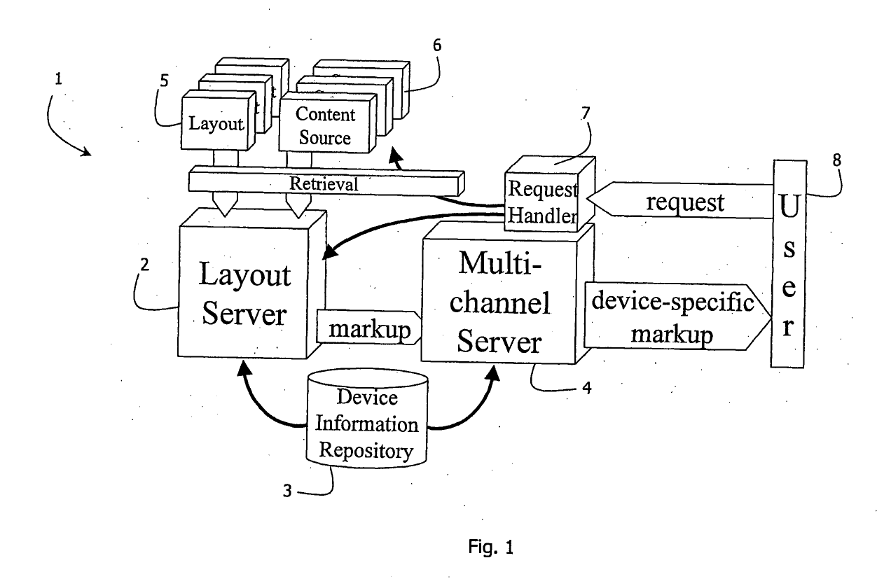

Referring to FIG. 1 a document transformation system 1 comprises a layout server 2 connected to an information repository 3 and to a multi-channel server 4. The layout server 2 interfaces with systems 5 providing layouts and systems 6 providing content. A request handler 7 is connected to a user interface 8.

The system 1 converts a source (or “original”) document to an output document having a different structure at the level of presentation of information. The output document is suitable for a particular user device in terms of the device's characteristics (software and hardware) and/or in terms of the delivery channel to be used. The layout server 2 deals with re-structuring of content and the multi-channel server 4 deals with additional lower-level transcoding for the particular delivery channels. This invention is concerned primarily with the re-structuring of content.

The structure of the delivered content is driven by a structural description, where such descriptions can be provided to the system 1 via fixed or dynamic means. This is a Model-View-Controller approach to generating channel-specific layouts.

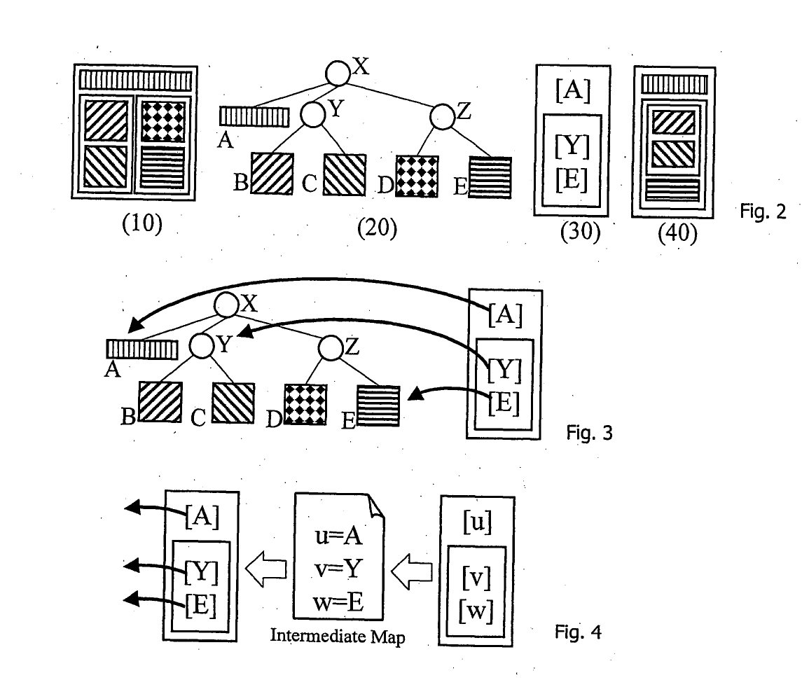

Referring to FIG. 2, part (10) shows an original source document with a nested structure and five content fragments illustrated by different shadings. Part (20) shows the structural hierarchy of the document from part (10). Part (30) shows a layout with references to structural elements in the hierarchy of part (20). Part (40) shows the resulting document after applying the layout from part (30). The documents in parts (10) and (40) employ the same markup language. If the language of the document in part (40) is not suitable for the viewing device, then a content transformation process can be applied to express the document in an alternative (markup) format. The purpose of the layout mechanism is to create a restructured document at the presentation level. The layout mechanism is not obliged to consume all possible source fragments, and this is illustrated in part (30) where the layout has no reference to fragment D indicated in part (20).

The system 1 includes intention markup (such as TML) that serves to describe the structure of the source document(s), and this structural information can be accessed by the layout mechanism of the layout server 2.

Re-Structuring

The server 2 requires as input the original structured document, a set of layouts (templates) that can be retrieved or generated, and a selection procedure to determine the appropriate layout for the delivery channel.

The Structured Input Document

The input documents are in an XML form, containing tags that describe a hierarchy structure within the document. When translated to a Document Object Model, the structural tags are represented as nodes in the model hierarchy. The structural nodes are mm-group tags with unique IDs. Any group of content within the input document can then be uniquely identified by its ID.

The location of the source document is indicated by a request (normally from the end user via the content browser), to which a layout is subsequently applied. Alternatively, the layout is indicated prior to any indication of the source content.

The layout contains references to source fragments from one or more source documents or content-producing processes.

Where the content is indicated first, the approach is called the “push mode” and where the layout indicates the source content the approach is called the “pull mode”. In the push mode, content from the source document is pushed into the layout, matching source fragments with layout placeholders. In the pull mode the layout contains a reference (typically a URL) to the source, and it pulls (fragments of) the source into the placeholders. It is permitted for both modes to be used simultaneously in any embodiment, where some content is pushed into a layout and where the layout also pulls content into itself.

The Layouts

A layout is an XML document containing placeholder tags that reference structural nodes within the source document(s). The references tags are mm-group-ref and mm-id-ref tags, and they refer to the mm-group or other identifiable tags of the source document(s). The layout document, when the reference tags are replaced by the content groups obtained from the source document(s), is then used as input to a content transformation process (which may be a null process) that transforms the content into a format that is intelligible to the target viewing agent. Thus the layout/groups combination produces a TML (Task/intention Markup Language) document that becomes input to the transformation engine of the multi-channel server 4.

References may be direct or indirect. A direct reference may indicate a specific named (via ID) tag within the source document, or an “anchored” fragment (content surrounded by a named anchor tag), or by any other available content (fragment) technology such as XPointer, as shown in FIG. 3.

An indirect reference indicates a notional structural element that can be mapped to a specific part of the source document, such that the notional structural reference is translated to a direct reference at the time when the layout is combined with the source. An association between the references in a layout to the fragments within the source is known as an “intermediate map”, as shown in FIG. 4.

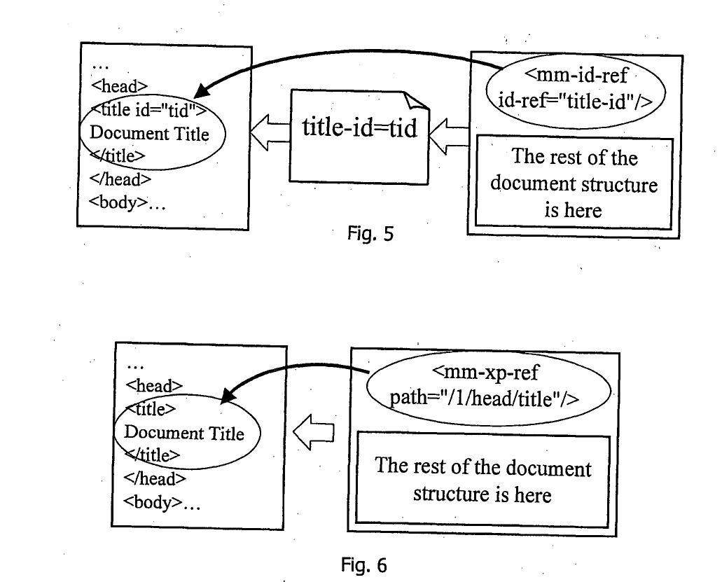

As examples of indirect references, an indirect reference may be used to associate the page header in the delivered document with the source text identified by the ID called “title-id” as illustrated in FIG. 5. An alternative indirect reference may indicate that the page header is associated with the text enclosed in the “title” tag of the source document (identified by the path to the title), irrespective of any ID assigned to the title, as shown in FIG. 6.

A layout document may be prepared in advance, and stored for retrieval/combination with selected groups. The layout document may also be generated at the time of the request for content. A layout placeholder may be replaced by more layout markup, which is subsequently processed. When the layout combination process supports this recursive interpretation, the system (server) is said to support “nested” layouts.

Indirect maps may also be prepared in advance, or generated at the time of the request for content.

In one embodiment, the layout descriptions for different devices and/or user preferences are stored as documents, which may be altered by an administrator and/or end user as appropriate.

In one embodiment, the layout descriptions are generated by a process within the mechanism such that the layout description is determined by a set of parameters.

In one embodiment, the layout descriptions are provided by the agent that supplies the source content.

The Server Configuration

Referring again to FIG. 1, the layout server 2 that implements the layout mechanism co-exists with the multi-channel server 4 that performs content transformation (translation from a source markup to a device-specific markup or format). It is the responsibility of the layout server 2 to enable the multi-channel server 4 to apply layouts to content. The integrated layout/multi-channel server combines the source content (fragments) with the layout and then transforms the resulting channel-neutral markup into a device-specific form.

Components of the Integrated Layout/Multi-Channel Server

Retrieval component: Using information obtained from the multi-channel server 4, the retrieval component seeks information from resources and makes this information available to the layout server 2. The information resources may be data in files, data in memory or data generated by processes. The resources may reside locally with the layout server 2, or may reside externally on other computing platforms and be accessed via a network. The retrieval component supplies the information to the layout server 2 in a format acceptable to the layout server 2 (i.e. markup fragments or simple text). Where the format of the data retrieved from an information resource is not acceptable to the layout server, the retrieval component may reformat (or transcode) the data. Since this would imply additional processing overhead, the preferred formats for the information resources are formats that are native to the layout server 2.

Layout Server 2: The layout server 2 combines layout templates with source content documents. Layout templates and content documents are obtained from the retrieval component, and are guaranteed by the retrieval component to be well formed and compatible with the combination process. The layout/source combination process is described separately.

Device Information Repository 3: This is a collection of descriptive properties associated with all devices, browsers and classes of devices and browsers that are supported by the system 1. These properties are name/value pairs, where the property name is a compound of identifying names, and where an identifying name is associated with any of the following: a specific device, a specific browser, a class of device, a class of browser, a specific content type, a class of content, any other named feature of the delivery channel. In this embodiment, the repository 3; comprises a database, where the identifying names are keys with which the repository is searched to determine values for named properties. Properties may be retrieved en masse from the repository 3 through the convenience of named collections of properties, so that all of the properties of a device or browser may be retrieved through a single query using the collection name as the search key. Collections and properties may be combined so that, for example, the properties of a device may be combined with the properties of a browser that runs in the device to determine the properties of the amalgamation of the device and the browser. As a specific example, a device that supports the display of colour, combined with a browser that does not support colour, will result in an amalgam that does not support colour (since this is the lesser of the capabilities). The combination of properties and collections of properties in this manner produces a final collection of properties that represent the delivery channel. It is this final collection that is provided to the layout server 2 to influence its generation of content via layouts and source documents. The same final collection of properties is made available to the multi-channel server to influence its generation of channel-specific content.

Request Handler 7: A request from the user is examined by the request handler 7 so that it may identify any session associated with the dialogue between the server and the user via session identifiers that accompany the request. The request handler 7 also separates the request from meta-data (such as headers). The request will be used to obtain a response for the user, and the meta-data will be used to influence the format and delivery of the response.

User 8: The source of requests and the target for content is represented by the user device. A user device may be a browser or device or some content handling agent acting on behalf of an end-user. The user requests are accompanied by meta-data that describes the form of the request and identifies some feature(s) of the user. In this embodiment, the user makes requests via the Hypertext Transport Protocol (HTTP) such that the request, being a combination of a URL and optional parameters, is accompanied by headers that may identify the device and/or browser. The request is used by the retrieval component to obtain a response (which will be processed via the layout server 2), and the headers are used by the device information repository to determine the properties of the delivery channel.

Multi-channel Server 4: This server accepts channel-neutral content from the layout server 2 and applies transformation to the content (using parameters from the device information repository 3) to ensure that the content is compatible with the delivery channel. The server 4 is also session-aware, and will use any session information obtained from the request handler 7 to sustain the session by ensuring that the session identifiers accompany the resulting content. In this embodiment, the multi-channel server 4 co-resides with the layout server 2 so that the document object model (DOM) representing the channel-neutral markup created by the layout server 2 is directly accessible to the multi-channel server 4, for reasons of efficiency.

The Layout Selection Process

In one embodiment, the selection/generation of the layout document is determined by a subset of the characteristics of the delivery channel such as the device/browser properties, the user preferences, and/or information contained within the source document. The device and channel characteristics are determined from the repository 3. It permits a number of layout selection methods. A simple unsophisticated method for selection is available: the administrator provides a single layout for each supported delivery channel. A more sophisticated method is also available: it takes a larger number of characterising parameters (including delivery properties, user preferences and source-embedded information) and uses these to generate a layout document for combination with the source. For example, a multicolumn layout may be generated where the number of columns is determined by the width of the browsing device, within a range of permitted numbers of columns as determined by the administrator and/or content supplier and/or the end user.

The Layout/Source Combination Process

The layout handling process and the source handling process are concomitant. The layout server 2 begins by parsing the source document, consuming the source document in reading order (beginning to end) and generating events based on what is consumed. The events are communicated via a “Simple Application Program Interface for extensible Markup Language” (Simple API for XML, also known as SAX). SAX is a recognised industry standard feature. The SAXEventHandler object in the server receives SAX events derived from the source document. A document object model (DOM) is built based on these events, so that the document is now represented by a hierarchy of objects.

The document may contain <mm-layout> tags. The “useragent” attribute of these tags refer to the device and/or browser type or class. Such tags are deemed to be applicable to the layout process if the useragent attribute matches the target user. Upon receipt of an event from the source document corresponding to an applicable <mm-layout> tag the parsing switches to the layout document. SAX events are now received from the layout document which continues to construct the DOM. Once parsing of the layout document is complete, parsing of the original source document resumes until completion. In this manner, parsing of the source and layout documents is interleaved to produce a final DOM. This DOM represents a merge of the layout and source documents.

When the end of the document is reached the DOM is instructed to transform itself. Consequently, all reference elements in the DOM are replaced by the elements they reference. At this point the DOM is a channel-neutral representation of the content to be delivered. In order to transform the content to a form suitable to the target device/browser, one of the following will happen:
Loose integration: the DOM is serialised via in-line traversal to a character stream thereby producing a channel-neutral document that can be delivered to a content transformation process in the multi-channel server 4, or
Tight integration: the DOM is accessed directly by the transformation process of the multi-channel server 4.

In another embodiment the DOM is not channel-neutral, the layout template making it specific to a particular delivery channel as well as user device.

In this embodiment, for efficiency, the multi-channel server 4 resides with the layout server 2 to facilitate tight integration, thereby eliminating the need for serialisation and subsequent parsing. This tight integration can be presented as a single server where layouts and source documents are input, and channel-specific content is output.

Content Creation

The creation of content involves the creation of source documents and layout documents. If the structure of the source document is prescribed (such that the IDs are known in advance) then it is the responsibility of the layout creator to use the same IDs (directly or indirectly) in the layout. If the layout is prescribed, then it is the responsibility of the source document creator to use the same IDs expected by the layout. Layouts are likely to change less frequently than source documents in most usage scenarios. Therefore the normal case will involve layouts that are prescribed, and thereby requiring the source document creators to adhere to the IDs prescribed in the layouts. The use of indirect references will assist in the mapping from layout IDs to source IDs.

Data-Driven Behaviour

The system 1 is predominantly data-driven. The source and layout documents are data, from which an output document (also data) is generated. The layout document combined with content from an application may be provided from a collection of layouts (files) maintained by the content server, or provided to the server by the application, or generated dynamically by either the application or the server. It is therefore not necessary for layouts to be predetermined, or compiled, or stored by any specific participant in the delivery process, so long as the appropriate layout can be selected/generated and accessed when required, regardless of its origin. Since a layout is a document, it can be accessed by the content server using any of the content access facilities already available to the content server.

Example Data

This is a sample source document as used in an embodiment of the invention as described in the section entitled “The layout/source combination process”. It contains a single identified group of content, whose ID is “sample”. This document also contains an mm-layout tag that will provide additional information to the layout selection mechanism.

<mm-layout useragent=“smallbrowser/html” src=“my_layout.htm”/>
<div id=“sample”>
Content documents definition of div element
</div>

This is a sample layout document named my_layout.htm containing a reference to a content group named “sample”. This layout is used whenever the delivery channel involves a small HTML browser, as indicated by the mm-layout tag in the source document.

<html>
<body>
<mm-id-ref id-ref=“sample”/>
</body>
</html>

When the source and layout documents are combined, the resulting document is:

<html>
<body>
<div id=“sample”>
Content documents definition of div element
</div>
</body>
</html>

The invention is not limited to the embodiments described but may be varied in construction and detail.

1. A document transformation system comprising means for transforming a source document to a target document suitable for delivery to one of a plurality of potential user devices,
wherein the system comprises a layout server for identifying a suitable layout template according to characteristics of the user device, and for combining the layout template with a source document to provide an output document.

2. A system as claimed in claim 1, wherein the system further comprises a multi-channel server for performing additional transformation of the output document to provide the target document.

3. A system as claimed in claim 2, wherein the multi-channel server comprises means for performing lower-level channel-specific transformation.

4. A system as claimed in claim 1, wherein the system stores a bank of layout templates and a bank of source documents, and the templates and the source documents have inter-linked tags.

5. A system as claimed in claim 4, wherein the system comprises a request handler comprising means for dynamically linking a source document to a layout template according to both user request attributes and device characteristics.

6. A system as claimed in claim 5, wherein the layout server comprises means for operating in a push mode in which source document fragments are pushed into a layout template according to source document tags, and in a pull mode in which source document fragments are pulled into a layout template according to template tags.

7. A system as claimed in claim 1, wherein the system further comprises a device information repository of user device characteristics, and the layout server comprises means for determining user device characteristics for a session from the repository, and using the characteristics to choose a layout template.

8. A system as claimed in claim 1, wherein the layout templates have a hierarchical structure.

9. A system as claimed in claim 8, wherein each source document has a markup structure and the layout server comprises means for representing tags of the source document as nodes in a document object model.

10. A system as claimed in claim 8, wherein the layout template comprises placeholder tags that reference structural nodes within the source document, and the layout server comprises means for replacing tags by source document content fragments.

11. A system as claimed in claim 10, wherein the layout template placeholder tags directly reference source document content fragments.

12. A system as claimed in claim 10, wherein the layout template placeholder tags indirectly reference source document content fragments via an intermediate map.

13. A system as claimed in claim 1, wherein the layout template is structured so that the output document is also suitable for delivery on a particular delivery channel.

14. A computer program product comprising software code for completing a system as claimed in claim 1 when executing on a digital computer.
